(19) United States
(12) Patent Application Publication
(10) Pub. No.: US 2019/0183714 A1
(43) Pub. Date: Jun. 20, 2019

(54) ACTION ASSIST APPARATUS AND PRESSURIZATION APPARATUS

(71) Applicant: HONDA MOTOR CO., LTD., Tokyo (JP)

(72) Inventors: Hiroyuki GOTO, SAITAMA (JP); Shinji OKA, SAITAMA (JP)

(21) Appl. No.: 16/198,270

(22) Filed: Nov. 21, 2018

(30) Foreign Application Priority Data
Dec. 18, 2017 (JP) 2017-242031

(51) Int. Cl. A61H 3/00

(52) U.S. Cl. CPC A61H 3/00; A61H 2201/5061; A61H 2201/5071; A61H 2230/505; A61H 2201/165; A61H 2230/255; A61H 2003/007

(57) ABSTRACT

An action assist apparatus A includes a pad (23) configured to transmit an assist force to an assist region of a user. The pad (23) has a pressure sensor (23a) configured to detect a state of the assist region, and a first assist force application portion (23b) and a second assist force application portion (23c) which are switchable independently between an assist force transmitting state and a non-transmitting state. A control unit (65) switches the first assist force application portion (23b) and the second assist force application portion (23c) based on the state of the assist region.

### BACKGROUND OF THE INVENTION

### Field of the Invention

The present invention relates to an action assist apparatus configured to assist a user to act and a pressurization apparatus configured to apply a predetermined pressure to a predetermined pressurization region of a body of the user to collect data

### Description of the Related Art

Conventionally, an action assist apparatus is known which is configured to assist a user to act by mounting an assist mechanism on the legs, waist or arms of the user, causing the assist mechanism to generate assist force by using a driving force transmitted from an actuator and transmitting the assist force to a predetermined region (hereinafter, this region will be referred to as an “assist region”) of a body of the user.

As this type of action assist apparatus, there is, for example, an action assist apparatus in which an assist mechanism is made up by knitting a plurality of linear actuators, which are driven to stretch and contract, as a wearable equipment which covers from a lumbar region to a thigh region of a user (refer to Japanese Patent Laid-Open No. 2016-137146). In this action assist apparatus, part of the plurality of actuators is used to assist the user to act by applying an assist force to the user, and part of the other actuators is used to fix the action assist apparatus to the body of the user.

Incidentally, in a conventional action assist apparatus like the one described in Japanese Patent Laid-Open No. 2016-137146, depending on the type of action to assist, a large force is applied to an assist region (particularly, the skin of the region) of the user, resulting in fears that the assist region is pressurized.

As a method of suppressing such pressurization, it is considered to use a soft material for forming a part configured to transmit the assist force to the body of the user among the constituent parts of the action assist apparatus, or to increase an area where the part is brought into abutment with the body of the user to thereby reduce the pressure applied to a unit area. However, even though these methods are used, in the case where the action assist apparatus is worn for a ling time, the pressure is kept applied to the same region of the body of the user.

In addition, to design the action assist apparatuses, there are cases where tests are carried out in which pressure is kept applied to the same region of the body of the user for many hours to collect data. Then, even when such tests are carried out, the pressure is kept applied to the same region of the body of the user.

As a result, unless the pressurization of the region can be suppressed, a disturbance is caused by a change in the state of the region (for example, tension of the muscle), resulting in fears that acquired data is affected by the disturbance.

The present invention has been made in view of the situations described above, and an object of the invention is to provide an action assist apparatus and a pressurization apparatus which can suppress the pressurization of the body of a user even though they are used for many hours.

### SUMMARY OF THE INVENTION

According to an aspect of the invention, there is provided an action assist apparatus comprising: an actuator configured to generate driving force; an assist mechanism configured to transmit the driving force to a user as an assist force assisting the user to act; a sensor configured to detect information regarding a state of an assist region of the user to which the assist force is transmitted; and a control unit configured to control the actuator, wherein the assist mechanism has a plurality of assist force application portions, wherein each of the plurality of assist force application portions is switchable independently between a transmitting state in which the assist force is transmitted and a non-transmitting state in which the assist force is not transmitted based on a signal from the control unit, and wherein the control unit recognizes the state of the assist region of the user based on a detection result by the sensor and switches at least one assist force application portion selected from the plurality of assist force application portions from one to the other of the transmitting state and the non-transmitting state based on the recognition.

Here, the “state of the assist region” detected by the sensor means a temperature and color of a skin, a degree of tension (hardness) of a muscle, a flow velocity of blood at the assist region or a peripheral portion of the assist region.

In addition, the “information regarding the state of the assist region” means information necessary for the control unit to recognize the state of the assist region and includes information on the peripheral portion of the assist region and from which the state of the assist region can be estimated or calculated (in other words, information from which the state of the assist region can be recognized indirectly) as well as information on the assist region or information from which the state of the assist region can be recognized directly.

As the “sensor”, a contact type pressure sensor incorporated in the assist mechanism together with the assist force application portions is preferable. However, a sensor provided independently of the assist mechanism may be used, or a non-contact type sensor may also be used.

In the action assist apparatus configured in the way described above, the state of the assist region (in particular, the state of the skin) of the user is recognized based on the result of the detection by the sensor, and the assist force application portions provided in the assist mechanism are switched between the transmitting state and the non-transmitting state based on the recognized state.

Consequently, according to the action assist apparatus of the present invention, since the pressure applied to the assist region is controlled according to the state of the assist region, the pressurization on the assist region (and hence the mounting region) can be suppressed.

In the action assist apparatus of the present invention, the action assist apparatus preferably comprises: a requested assist force recognition element configured to recognize requested assist force which is the assist force requested to assist the user to act; and an estimated assist force recognition element configured to recognize an estimated assist force before the respective assist force application portion is switched, the estimated assist force being the assist force estimated to be applied to the user via the assist mechanism after the switching is executed, and preferably, the control unit compares the estimated assist force with the requested assist force, and in a case where the estimated assist force is smaller than the requested assist force, then stops at least one assist force application portion among the assist force application portions which is in the transmitting state from being switched to the non-transmitting state such that the assist force larger than the requested assist force can be transmitted.

In the case where the control is executed based only on the state of the assist region, there may be a case where the assist force becomes insufficient for the reason that the number of assist force application portions configured to transmit the assist force to the assist region is too small Additionally, depending on the set switching threshold, the number of times of switching is increased, leading to fears that an increase in consumed power is called for.

Then, in this way, since the switching of the assist force application portions is limited based on the requested assist force which is the assist force requested to assist the user to act and the estimated assist force which is the assist force applied to the user via the assist region after the switching is executed in addition to the state of the assist region, the number of times of switching can be appropriate while suppressing the insufficiency in assist force. Then, this can suppress not only an increase in consumed power but also an increase in size of the whole of the apparatus including a battery.

In the action assist apparatus according to the present invention, preferably, the action assist apparatus comprises: a requested assist force recognition element configured to recognize requested assist force which is the assist force requested to assist the user to act; an estimated assist force recognition element configured to recognize estimated assist force before the respective assist force application portion is switched, the estimated assist force being the assist force estimated to be applied to the user via the assist mechanism after the switching is executed; an informing unit configured to inform the user that the estimated assist force is smaller than the assist force; and a stop request recognition element configured to recognize a request from the user to stop the switching, and the control unit compares the estimated assist force with the requested assist force, and in a case where the estimated assist force is smaller than the requested assist force, informs the user, and upon recognizing a signal from the stop request recognition element, stops at least one assist force application portion among the plurality of assist force application portions in the transmitting state from being switched to the non-transmitting state such that the assist force larger than the requested assist force can be transmitted.

As described above, since the switching of the assist force application portions is controlled based on the requested assist force and the estimated assist force in addition to the state of the assist region, the number of times of switching can be appropriate, while suppressing the insufficiency in assist force.

However, whether obtaining assist force takes priority over suppressing the pressurization or suppressing the pressurization takes priority over obtaining assist force changes at all times depending upon the purpose of utilization by the user. Thus, in the case where the switching is controlled based only on the determination at the control unit, the timing at which the switching is executed differs from the timing requested by the user, leading to fears that the user is caused to feel a sensation of physical disorder.

Then, in the way described above, since the control unit can inform the user that the estimated assist force is smaller than the requested assist force (that is, the switching needs to be limited) and can recognize a request to stop the switching from the user, the switching can be executed at the appropriate timing which matches the request of the user. This can makes it difficult for the user to feel a sensation of physical disorder.

In the action assist apparatus of the present invention, preferably, the sensor detects at least one of the state of the assist region, a pressure applied to the assist region, a time period during which the assist force is applied to the assist region, a sum of time periods of the transmitting state of each of the assist force application portions, and a number of times each of the assist force application portions became the transmitting state.

Since the parameters described above are referred to in recognizing the state of the assist region, it becomes easy to recognize the state of the assist region accurately.

In the action assist apparatus of the present invention, preferably, the plurality of assist force application portions include a first assist force application portion and a second assist force application portion, and the control unit switches the second assist force application portion to the non-transmitting state when transmitting the first assist force application portion to the transmitting state.

In this way, since the two assist force application portions make a pair, the switching control can be simplified.

In the action assist apparatus of the present invention, the plurality of assist force application portions are disposed on an abutment surface which is brought into abutment with a body of the user so as to be aligned adjacent to one another.

In the action assist apparatus of the present invention, the action assist apparatus may comprise: a first mounting device adapted to be mounted on a first assist region of a body of the user; and a second mounting device adapted to be mounted on a second assist region which is a portion different from the portion on which the first mounting device is mounted, and part of the plurality of assist force application portions may be disposed on the first mounting device and the other part may be disposed on the second mounting device.

According to another aspect of the invention, there is provided a pressurization apparatus comprising: an actuator configured to generate a driving force; a plurality of pressure application portions configured to apply a predetermined pressure based on the driving force to a pressurization region of a body of a user; a sensor configured to detect information regarding a state of the pressurization region of the user; and a control unit configured to control the actuator, wherein each of the plurality of pressure application portions is switchable independently between a transmitting state in which pressure is transmitted and a non-transmitting state in which no pressure is transmitted based on a signal from the control unit, and wherein the control unit recognizes the state of the pressurization region of the user based on a detection result by the sensor and switches at least one pressure application portion selected from the plurality of pressure application portions from one of the transmitting state and the non-transmitting state to the other based on the recognition.

In the pressurization apparatus configured as described above, the pressure application portions are switched between the transmitting state and the non-transmitting state based on the state of the pressurization region of the user (particularly, the state of the skin) which is detected by the sensor.

For example, in the case where the pressurization region is recognized as being kept pressurized for a long period of time as a result of the detection by the sensor, the pressure application portion located in a position corresponding to the pressurization region is switched from the transmitting state to the non-transmitting state. This stops the pressure application portion from transmitting the pressure or changes the position where pressure is transmitted, whereby the pressure applied to the pressurization region is reduced.

Consequently, according to the pressurization apparatus of the present invention, since the pressure applied to the pressurization region is reduced according to the state of the pressurization region, the pressurization on the pressurization region (then, the mounting region including a plurality of pressurization regions) can be suppressed. In addition, an occurrence of disturbance can be suppressed which is triggered by a change in the state of the pressurization region (for example, a tension of muscle).

### BRIEF DESCRIPTION OF THE DRAWINGS

FIG. 1 is a front perspective view of an action assist apparatus according to an embodiment;

FIG. 2 is a rear perspective view of the action assist apparatus illustrated in FIG. 1;

FIG. 3A is an explanatory drawing illustrating schematically the configuration of an assist force application unit of the action assist apparatus illustrated in FIG. 1, being particularly a sectional view illustrating a state before switching is executed;

FIG. 3B is an explanatory drawing illustrating schematically the configuration of the assist force application unit of the action assist apparatus illustrated in FIG. 1, being particularly a plan view illustrating a state before switching is executed;

FIG. 3C is an explanatory drawing illustrating schematically the configuration of the assist force application unit of the action assist apparatus illustrated in FIG. 1, being particularly a sectional view illustrating a state after switching is executed;

FIG. 3D is an explanatory drawing illustrating schematically the configuration of the assist force application unit of the action assist apparatus illustrated in FIG. 1, being particularly a plan view illustrating a state after switching is executed;

FIG. 4 is a block diagram illustrating a system configuration of a control unit of the action assist apparatus illustrated in FIG. 1; and

FIG. 5 is a flow chart illustrating a process executed when the assist force application unit is switched in function in the action assist apparatus illustrated in FIG. 1.

### DETAILED DESCRIPTION OF THE PREFERRED EMBODIMENT

Hereinafter, referring to drawings, an action assist apparatus A according to an embodiment of the present invention will be described.

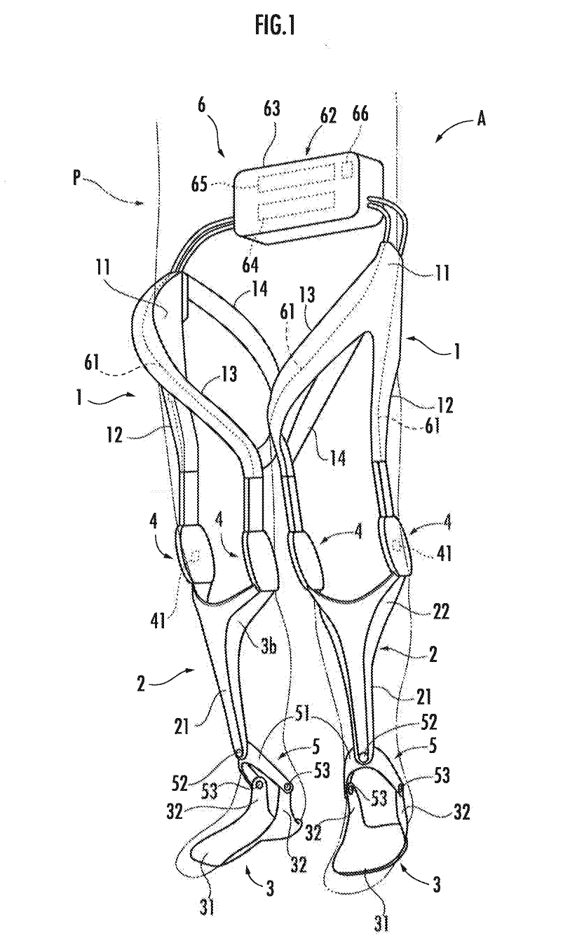

Firstly, referring to FIGS. 1, 2 and 3A to 3D, a schematic configuration of the action assist apparatus A will be described. The action assist apparatus A is an apparatus worn by a user P (a human being) to assist the user P to move his or her legs when the user P walks.

In this embodiment, as an example of an action assist apparatus of the present invention, a so-called waking assist apparatus will be described which is configured to assist the user to move his or her legs when the user walks. However, the action assist apparatus of the present invention is not limited to such a waking assist apparatus and hence, may be any action assist apparatus configured to assist a user to act. For example, the action assist apparatus of the present invention may be an action assist apparatus configured to apply an assist force to the arms and lumbar of the user to assist the user to perform a lift-up action.

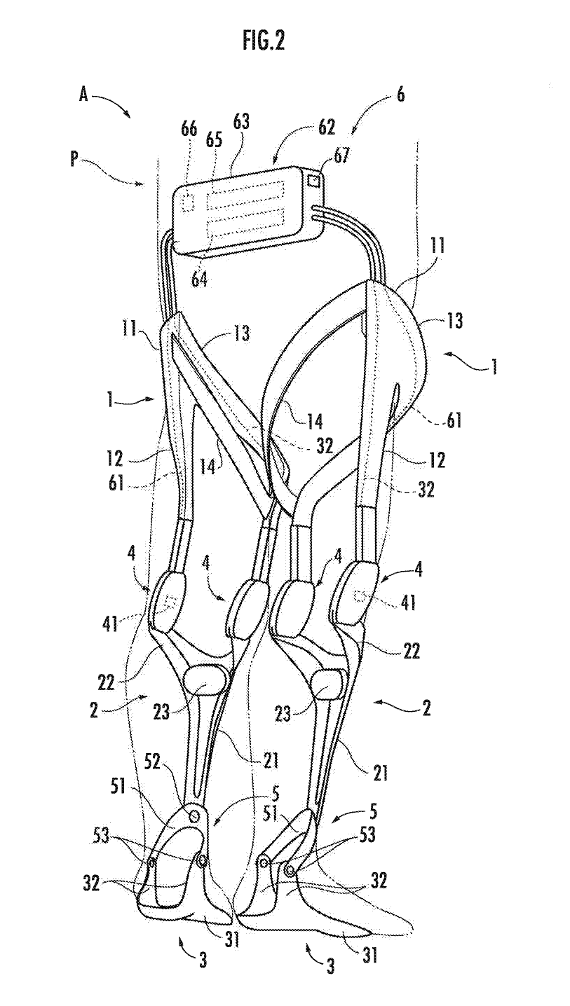

As illustrated in FIGS. 1 and 2, the action assist apparatus A comprises, as frames mounted on legs of the user P, thigh region frames 1, lower leg region frames 2 (assist mechanisms), and foot region frames 3.

The action assist apparatus A comprises, as joint mechanisms provided on each leg, a pair of knee joint mechanisms 4 configured to couple the thigh region frame 1 and the lower leg region frame 2 together so as to be displaced relatively and an ankle joint mechanism 5 configured to couple the lower leg region frame 2 and the foot region frame 3 together so as to be displaced relatively. A driving force is transmitted to the knee joint mechanisms 4 from a joint power generation device 6.

In the action assist apparatus A, the frames and the joint mechanisms to be mounted on the legs of the user P are each mounted on the target legs so as to move together with the corresponding thigh regions, lower leg regions and foot regions of the legs.

The expression reading that the thigh region frame 1 “moves together” with the thigh region means that the thigh region frame 1 moves together with the thigh region of the leg so that the position and posture of the thigh region frame 1 are maintained constant or substantially constant with respect to the thigh region of the leg.

This can permit the position and posture of the thigh region frame 1 to slightly change as the leg moves on which the thigh region frame 1 is mounted (the thigh region frame to be displaced slightly relative to the thigh region of the leg). This will be true with a case where the lower leg region frame 2 and the foot region frame 3 “move together with” the corresponding lower leg region and foot region, respectively.

The pair of knee joint mechanisms 4 is disposed separately at both sides of the knee (an outer side and an inner side of the knee) in a left-and-right direction (a pitch axis direction) of the leg of the user P with the knee mechanism mounted on the leg of the user P.

In the description of this embodiment, an inner side and an outer side of each region (the knee, the thigh region, and the like) of each leg of the user P mean, of both sides of the leg in the left-and-right direction, a side lying near the other leg (a side facing the other leg) and a side lying far from the other leg, respectively. That is, an inner side and an outer side of the right leg of the user P are a left side and a right side of the right leg, respectively, and an inner side and an outer side of the left leg are a right side and a left side of the left leg, respectively.

In the description of this embodiment, unless otherwise mentioned, the left-and-right direction (or the pitch axis direction), a front-and-rear direction (or a roll axis direction) and an up-and-down direction (or a yaw axis direction) mean a left-and-right direction, a front-and-rear direction, and an up-and-down direction of the user P, respectively, with the user P wearing the action assist apparatus A standing in an almost upright posture. Additionally, the pitch direction, the roll direction, and the yaw direction mean a rotational direction in a direction about a pitch axis, a rotational direction in a direction about a roll axis, and a rotational direction in a direction about a yaw axis, respectively.

The thigh region frame 1 has, as its base body frames, a first element frame 12 and a second element frame 13 which extend from a thigh side base portion 11 into two branches. The first element frame 12 and the second element frame 13 are formed of an integrally molded relatively hard resin member. The first element frame 12 and the second element frame 13 may be a structure into which a plurality of members are joined to be integrated.

The thigh side base portion 11, which is a root portion of the first element frame 12 and the second element frame 13, is a site of the action assist apparatus A which is disposed on one side of the waist region at a height which is equal to or higher than a root of inner sides of the legs of the user P (a portion where inner surfaces of both the legs intersect) and is lower than a hipbone. The “one side of the waist region” is a right side of the waist region for the thigh region frame 1 for the right leg of the user P and is a left side of the waist region for the thigh region frame 1 for the left leg.

The first element frame 12 is an element frame which is connected to the knee joint mechanism 4 in which the thigh side base portion 11 is positioned outwards. The first element frame 12 extends from the thigh side base portion 11 in a longitudinal direction of the thigh region of the user P along an outer surface of the thigh region to reach the knee joint mechanism 4 positioned on the outer side of the knee.

The second element frame 13 is an element frame which is connected to the knee joint mechanism 4 in which a thigh side base portion 11 is positioned inwards. The second element frame 13 extends from the thigh side base portion 11, passes a front surface side of the thigh region of the user P (passes around the front surface side of the thigh region) and reaches the knee joint mechanism 4 positioned on the inner side of the knee.

The first element frame 12 and the second element frame 13 are connected to the knee joint mechanism 4 which is positioned outwards and the knee joint mechanism 4 which is positioned inwards, respectively, at their lower end portions.

The thigh region frame 1 comprises a body support member 14 which is stretched between the thigh side base portion 11 and a lower portion of the second element frame 13. The body support member 14 supports the thigh region of the user P from a rear surface side of the thigh region. The body support member 14 is provided in such a way that the thigh region of the user P can be inserted between the second element frame 13 and itself.

The body support member 14 is formed into the shape of a relatively thin belt so as to reduce as much a possibility as possible that the user P feels a sensation of touching a foreign matter at the thigh region or a buttock region when the user P sits on a chair. The body support member 14 is given a lower rigidity than those of the first element frame 12 and the second element frame 13. Specifically, the body support member 14 is formed of a resin member that is softer than the first element frame 12 and the second element frame 13 or a fabric member.

The lower leg region frame 2 has, as its base body frames, a lower leg side base portion 21, which is disposed on a front side of the lower leg region of the user P so as to extend in a longitudinal direction of the lower leg region, a branched portion 22, which extends from an upper portion of the lower leg side base portion 21 so as to pass around both the sides (the outer side and the inner side) of the knee of the user P.

Of a pair of distal end portions of the branched portion 22, a distal end portion on the inner side of the knee is connected to the second element frame 13 of the thigh region frame 1 via the knee joint mechanism 4 positioned inwards. On the other hand, a distal end portion on the outer side of the knee is connected to the first element frame 12 of the thigh region frame 1 via the knee joint mechanism 4 disposed outwards.

An upper portion (a root portion of the branched portion 22) of the lower leg side base portion 21 covers a front surface of an upper portion of the lower leg region (specifically, the tibial tuberosity). The upper portion of the lower leg side base portion 21 constitutes a portion configured to be brought into abutment with the tibial tuberosity of the lower leg region to transmit an assist force assisting the user P to act when the user P bends and stretches the legs. Due to this, a pad 23 is securely fixed to an inner surface of the upper portion of the lower leg side base portion 21.

The foot region frame 3 has a bottom plate portion 31 which is a plate-shaped frame on which a foot region of the user P rests and rising portions 32 rising from both sides of a portion of the bottom plate portion 31 which lies closer to a heel of the foot region.

The bottom plate portion 31 is formed into an insole shape which is substantially similar to an insole of a shoe or a shape a part of the insole shape remaining after cutting partially the insole shape (for example, a shape resulting from cutting a front part or a rear part of the insole).

The rising portions 32 are connected to a lower end portion of the lower leg region frame 2 (a lower end portion of the lower leg side base portion 21) via the ankle joint mechanism 5. The rising portions 32 are disposed so as to be positioned on an inner side and an outer side of the heel of the ankle of the user P with the foot region of the user P resting on the bottom plate portion 31.

The knee joint mechanism 4 positioned outwards and the knee joint mechanism 4 positioned inwards have almost the same construction. Each knee joint mechanism 4 moves in a similar manner to a manner in which the knee joint of a general human being moves to enable the leg of the human being to contract and stretch (a relative displacement motion between the thigh region and the lower end portion) to thereby realize a stretching and contracting action (a relative displacement motion between the thigh region frame 1 and the lower leg region frame 2) of the joint mechanism by making use of the motion of the knee joint mechanism 4.

An action sensor 41, which is configured to recognize an action of the knee of the user P, is incorporated in the knee joint mechanism 4. The action sensor 41 may be any sensor as long as the sensor can recognize an action of the knee of the user P. An angle sensor configured to recognize a bending and stretching angle of the knee, an angle sensor configured to detect an angular velocity of the knee, a speed sensor configured to detect a moving speed of the leg, or a sensor which is a combination of the sensors described before is used as the action sensor 41.

The ankle joint mechanism 5 includes a link member 51 of a substantially semi-arc shape (or a substantially U shape) which is disposed so as to surround a front circumference of an ankle region of the user P.

The link member 51 is connected to the lower end portion of the lower leg region frame 2 at a central portion of the link member 51 via a first joint shaft 52 in a roll axis direction. Due to this, the link member 51 is supported rotatably about an axis of the first joint shaft 52 so as to rotate in the roll direction relative to the lower leg region frame 2.

The link member 51 is connected to the rising portions 32 of the foot region frame 3 (specifically, the rising portions 32 on the same sides as the sides where end portions of the link member 51 are situated with respect to the inner side and the outer side of the heel of the user P) at the lower end portions via second joint shaft 53 in the pitch axis direction.

The second joint shaft 53 on the inner side and the second joint shaft 53 on the outer side of the heel of the user P are disposed coaxially Due to this, the link member 51 is supported rotatably so as to rotate about axes of the inner and outer second joint shafts 53 (in the pitch direction) relative to the foot region frame 3.

In this embodiment, the ankle joint mechanism 5 does not have a joint axis in the yaw direction (the up-and-down direction). However, when the foot region of the user P is rotated in the yaw direction with respect to the lower leg region, the lower leg side base portion 21 of the lower leg region frame 2 is twisted. This enables the foot region frame 3 to be rotated in the yaw direction relative to the lower leg region frame 2. This allows the user P to move the foot region into an arbitrary posture with respect to the lower leg region.

The ankle joint mechanism 5 may comprise a joint shaft in the yaw direction.

The joint power generation device 6 comprises wires 61 which are inserted through an interior of the thigh region frame 1 so as to move back and forth and an assist force application mechanism 62 configured to apply a tension variably to the wires 61.

Ends of the wires 61 are connected to the assist force application mechanism 61 and the other ends of the wires 61 are connected to the knee joint mechanisms 4.

The assist force application mechanism 62 controls a tension on the wires 61 according to a relative displacement (that is, leg bending and stretching actions) between the thigh region frame 1 and the lower leg region frame 2 via the knee joint mechanisms 4 to generate a joint power (that is, an assist force) in the knee joint mechanisms 4.

The assist force application mechanism 62 comprises an actuator 64 configured to generate a driving force to apply a tension to the wires 61 and a control unit 65 configured to control the driving of the actuator 64 within an interior of a housing 63 of the assist force application mechanism 62.

The housing 63 is mounted on an upper side of the waist region on a back side of the user P via a belt (not illustrated) in such a manner as to move almost together with an upper body of the user P. The mounting position of the housing 63 should be any position as long as the position interrupts the motion of the user P. For example, the housing 63 may be mounted on the back of the user P or on the upper body on an abdomen region side.

The actuator 64 works in cooperation with an elastic member, a pulley, an electric motor, a reduction gear, and the like (none of them is illustrated) which are incorporated in the housing 63 or the thigh region frame 1 to apply a tension on the wires 61. Then, the assist force is transmitted to assist regions of the user P via the pads 23 of the lower leg region frames 2 (the assist mechanisms) and the body support members 14 of the thigh region frames 1 which are connected to the wires 61.

The control unit 65 is made up of an electronic circuit unit including a CPU, a RAM, a ROM, an interface circuit, and the like. The control unit 65 is made up of a plurality of electronic circuit units which can communicate with each other.

As will be described later, the control unit 65 controls the actuator 64, the electric motor, and the reduction gear based on a signal from a pressure sensor 23a incorporated in the pad 23. Namely, the control unit 65 controls the assist force transmitted to the user P.

The assist force application mechanism 62 comprises a speaker 66 (an informing unit) configured to inform the user P based on a signal from the control unit 65 and a switching stop switch 67 configured to be used by the user P to instruct the control unit 65 to stop a switching control. The speaker 66 is incorporated in the housing 63. The switching stop switch 67 is provided on a side surface portion of the housing 63.

The informing unit is not limited to the speaker 66 configured to output audio information, and hence, any informing unit may be adopted, as long as the informing unit can cause the user to recognize what is informed of. For example, a display may be provided on the housing, or the housing may be vibrated to cause the user to be aware of which is informed of.

An instruction issued from the user P to stop the switching control may be recognized through voice recognition in place of the switching stop switch.

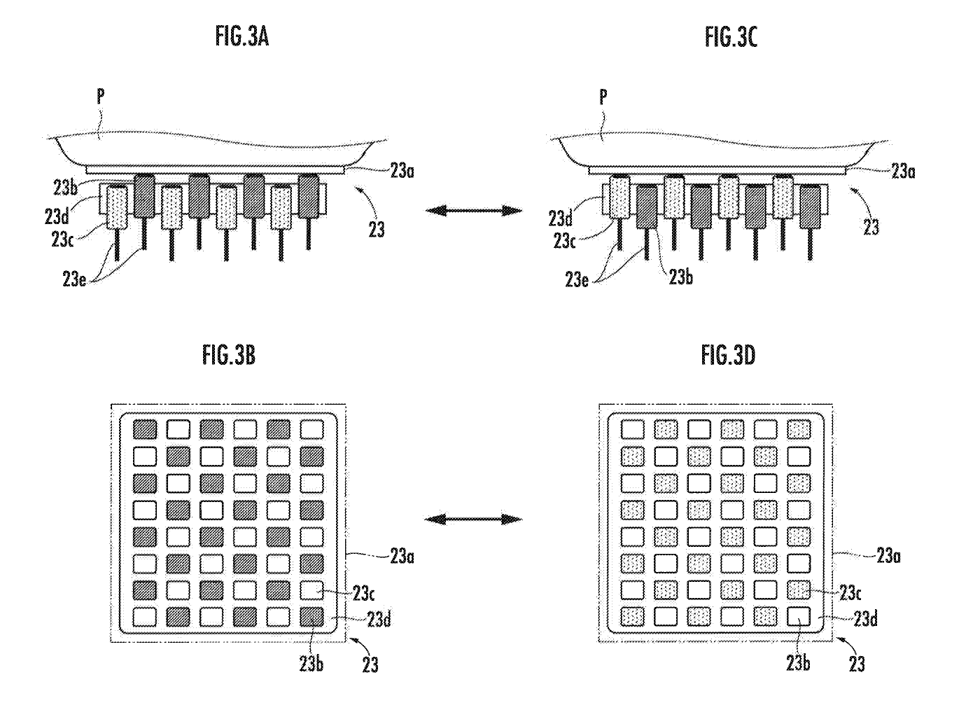

Next, referring to FIGS. 3A to 3D, the construction of the pad 23 will be described in detail.

The pad 23 comprises a sheet-shaped pressure sensor 23a configured to be brought into abutment with the user P, and a plurality of first assist force application portions 23b and a plurality of second assist force application portions 23c which are disposed between the pressure sensor 23a and the lower leg side base portion 21 (refer to FIG. 2) of the lower leg region frame 2.

As illustrated in FIGS. 3A and 3C, the plurality of first assist force application portions 23b and the plurality of second assist force application portions 23c are both pillar-shaped members held in a pad case 23d of the pad 23 so as to move back and forth in an axial direction independently.

Air cylinders 23e are connected to respective lower portions of the first assist force application portions 23b and the second assist force application portions 23c. The first assist force application portions 23b and the second assist force application portions 23c are individually moved towards or away from the assist regions of the user P by means of a driving force from the corresponding air cylinders 23e.

Here, respective operations of the air cylinders 23e are controlled independently based on a signal from the control unit 65 (refer to FIGS. 1 and 2). Namely, the plurality of first assist force application portions 23b and the plurality of second assist force application portions 23c are freely switchable based on a signal from the control unit 65 between a transmitting state where the first assist force application portions 23b and the second assist force application portions 23c stay proximate to the assist region of the user P so as to transmit the assist force to the assist region and a non-transmitting state where the first assist force application portions 23b and the second assist force application portions 23c stay away from the assist region so as not to transmit the assist force to the assist region.

As power supplies to the first assist force application portions 23b and the second assist force application portions 23c, various types of power supplies may be used which include hydraulic cylinders and the like, in addition to the air cylinders 23e.

As to the first assist force application portions 23b and the second assist force application portions 23c, the invention is not limited to the configuration described in this embodiment in which the pillar-shaped members are made to move back and forth. Hence, any configuration may be adopted as long as the configuration can switch the first assist force application portions 23b and the second assist force application portions 23c between the transmitting state and the non-transmitting state.

For example, a plurality of linear members each configured to control its tension may be knitted into an assist force application unit, whereby the assist force application unit is switched between the transmitting state and the non-transmitting state by controlling the tensions of the linear members.

As illustrated in FIGS. 3B and 3D, the plurality of first assist force application portions 23b and the second assist force application portions 23c are disposed adjacent to each other to form a mosaic pattern. By adopting this configuration, an abutment surface having irregularities (refer to FIGS. 3A and 3C) is formed by distal end faces of the plurality of first assist force application portions 23b and distal end faces of the plurality of second assist force application portions 23c.

The arrangement pattern of the plurality of first assist force application portions 23b and the plurality of second assist force application portions 23c is not limited to the mosaic pattern and hence may be designed as required according to the direction in which the assist force is transmitted to the user P. For example, a row of first assist force application portions arranged in the left-and-right direction as seen from above and a row of second assist force application portions arranged in the left-and-right direction as seen from above may be aligned alternately with each other in the up-and-down direction.

As illustrated in FIGS. 3A and 3C, the sheet-shaped pressure sensor 23a is placed on the abutment surface formed by the first assist force application portions 23b and the second assist force application portions 23c. Due to this, a surface of the sheet-shaped pressure sensor 23a is brought into direct abutment with the assist region (in this embodiment, a site lying below the knee of the user P and with which the pad 23 is brought into abutment) of the user P to which the assist force is transmitted.

This is because the first assist force application portions 23b and the second assist force application portions 23c are brought into direct abutment with the assist region of the user P, whereby the user P is prevented from feeling a sensation of uncomfortableness at the assist region.

When cushion members are provided separately at the distal end portions (that is, portions which are brought into direct abutment with the assist region) of the first assist force application portions 23b and the second assist force application portions 23c, the pressure sensor 23a may be disposed closer to the lower leg side base portion 21 than the first assist force application portions 23b and the second assist force application portions 23c.

The control unit 65 recognizes a magnitude and distribution of a pressure applied to the assist region based on a signal from the pressure sensor 23a and estimates a state of the assist region of the user P based on the recognition.

In this embodiment, a pressure applied to the assist region of the user P is detected by use of the pressure sensor 23a as a parameter for recognizing a state of the assist region. In the present invention, however, the parameter for recognizing the state of the assist region is not limited to the pressure detected directly as being applied to the assist region, and hence, any information may be used, as long as the information informs of the state of the assist region.

Here, the “state of the assist region” detected by the sensor means a temperature and color of a skin, a degree of tension (hardness) of a muscle, a flow velocity of blood at the assist region or a peripheral portion of the assist region.

In addition, the “information regarding the state of the assist region” means information necessary for the control unit to recognize the state of the assist region and includes information on the peripheral portion of the assist region and from which the state of the assist region can be estimated or calculated (in other words, information from which the state of the assist region can be recognized indirectly) as well as information on the assist region or information from which the state of the assist region can be recognized directly.

Specifically, the information regarding the state of the assist region includes, in addition to the pressure applied to the assist region, a state of the assist region, a time period during which the assist force is applied to the assist region, a sum of time periods during which the individual assist force application portions stay in the transmitting state, and the number of times the individual assist force application portions are switched to the transmitting state, as well as a combination of two or more of the parameters described above.

Due to this, as the “sensor”, a contact type pressure sensor incorporated in the assist mechanism together with the assist force application portions, a temperature sensor, and the like may be used according to information to be detected. Additionally, an optical sensor of a non-contact type may be used which is provided independently of the assist mechanism.

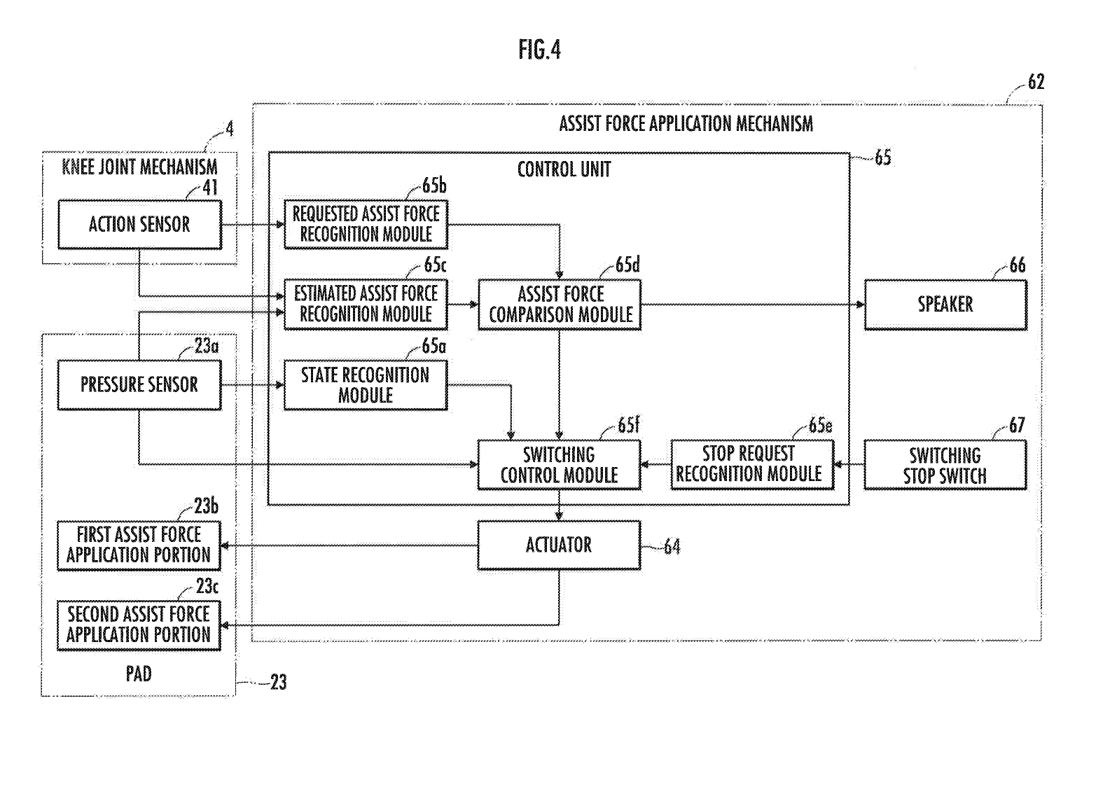

Next, referring to FIG. 4, the control unit 65 will be described in detail. In assisting the user P to act, the control unit 65 controls the switching of the plurality of first assist force application portions 23b and the plurality of second assist force application portions 23c between the transmitting state and the non-transmitting state (hereinafter, referred also to simply as a “switching control”) by controlling the driving of the actuator 64.

Hereinafter, an assist force required to assist the user P to act will be referred to as a “requested assist force”, and an assist force which is estimated to be applied to the user P via the pad 23 after the control unit 65 executes the switching control will be referred to as an “estimated assist force”.

The control unit 65 comprises, as functions realized by a mounted hardware configuration or program, a state recognition module 65a configured to recognize a state of the assist region of the user P, a requested assist force recognition module 65b configured to recognize a requested assist force, an estimated assist force recognition module 65c configured to recognize an estimated assist force before the switching control is executed, an assist force comparison module 65d configured to compare the requested assist force with the estimated assist force, a stop request recognition module 65e configured to recognize a stop request made by the user P to stop the switching control, and a switching control module 65f configured to execute the switching of the states of the assist force application portions through the actuator 64. These functional modules execute their operations one after another.

The state recognition module 65a recognizes a magnitude and distribution of a pressure applied to the assist region and a pressurization time based on a signal from the pressure sensor 23a, estimates a state of the assist region of the user P based on the recognition, and determines whether or not the switching control is necessary based on the result of the estimation.

To describe the operations of the functional modules in detail, the state recognition module 65a recognizes a transmitting state continuing time of and a pressure applied by each of the plurality of first assist force application portions 23b and the plurality of second assist force application portions 23c, calculates a degree of damage at each area of the assist region of the user P based on the recognized time and pressure, and determines whether or not the degree exceeds a predetermined threshold (that is, whether or not an execution of the switching is required).

The requested assist force recognition module 65b estimates an action of the user P based on a signal from an action sensor 41 that the knee joint mechanism 4 comprises and calculates a requested assist force for the action.

The estimated assist force recognition module 65c estimates an action of the user P base on a signal from the pressure sensor 23a and a signal from the action sensor 41 that the knee joint mechanism 4 comprises and calculates an estimated assist force for a case where the switching control is executed based on a predetermined switching pattern.

Here, the predetermined switching pattern means something like a predetermined switching pattern executed when the same action is repeated in the case where a switching stop request, which will be described later, is not made.

In this embodiment, in switching one of the first assist force application portions 23b and the second assist force application portions 23c to the transmitting state, a switching pattern in which the other is switched to the non-transmitting state is referred to as a predetermined switching pattern. This is because the operation performed when the switching control is executed is made simple.

The assist force comparison module 65d compares the requested assist force recognized by the requested assist force recognition module 65b with the estimated assist force recognized by the estimated assist force recognition module 65c and transmits the result of the comparison to the switching control module 65f. In the case where the result of the comparison finds that a fact the estimated assist force is smaller than the requested assist force, the user P is informed of the fact via the speaker 66.

The stop request recognition module 65e recognizes whether or not the user P has depressed the switching stop switch 67 (that is, whether or not the user P has made a request to stop the switching control) within a predetermined period of time set in advance after the user is informed of the fact that the assist force is insufficient via the speaker 66.

The switching control module 65f selects targets to be switched and targets whose current states are maintained from the plurality of first assist force application portions 23b and the plurality of second assist force application portions 23c and executes the switching of the selected targets via the actuator 64.

As this occurs, the targets are selected based on the state of the assist region of the user P which is recognized by the state recognition module 65a, the results of the comparison made by the assist force comparison module 5d between the requested assist force and the estimated assist force, and whether or not the stop request recognition module 65e recognizes the stop request, or based on the predetermined switching pattern set in advance.

In the action assist apparatus A of this embodiment, the requested assist force and the estimated assist force are recognized based on the information sent from the action sensor 41 that the knee joint mechanism 4 comprises. However, the present invention is not limited to this configuration.

For example, a configuration may be adopted in which a data base is provided which stores in advance information on the requested assist force and the estimated assist force, and the requested assist force and the estimated assist force are obtained from the data base as required.

In the action assist apparatus A of this embodiment, the switching control based on the predetermined switching pattern is corrected based on the requested assist force and the estimated assist force. However, the configuration of the present invention is not limited to that configuration.

For example, a configuration may be adopted in which an assist force application portion to be switched on the basis of real time is calculated based only on a signal from the pressure sensor and the switching control is executed based on the result of the calculation. For example, a configuration may be adopted in which the switching control is executed based only on the predetermined switching pattern and is not corrected based on the requested assist force and the estimated assist force. In this case, the requested assist force recognition module and the estimated assist force recognition module may be omitted.

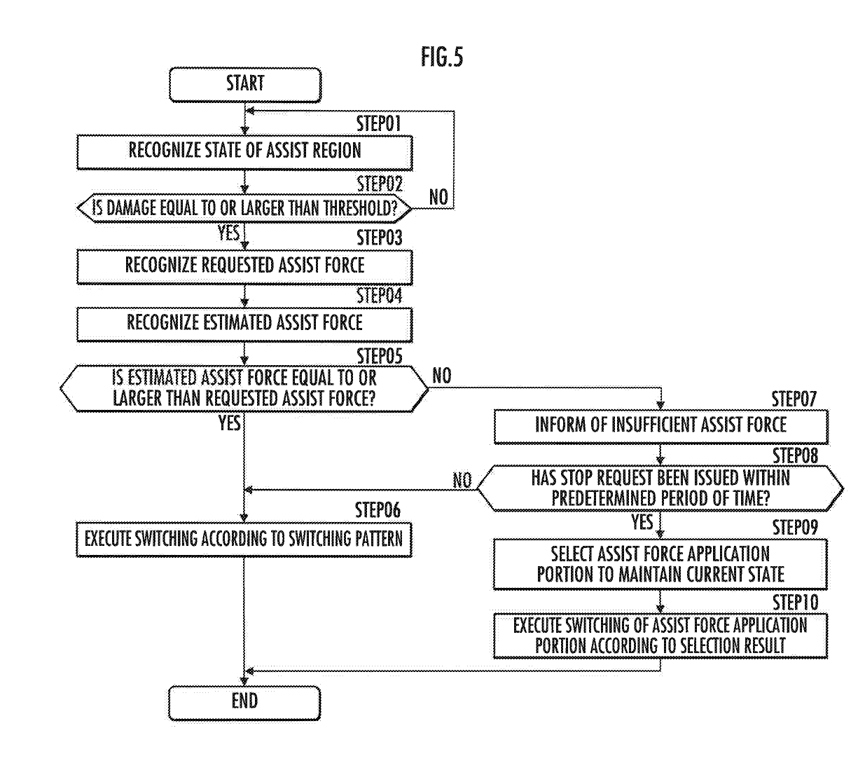

Nest, referring to FIGS. 4 and 5, operations or processes executed at the individual functional modules of the control unit 65 when the switch control is executed will be described. FIG. 5 is a flow chart illustrating processes executed by the control unit 65 when it executes the switching control.

Firstly, the state recognition module 65a recognizes the magnitude and distribution of a pressure applied to the assist region and a pressurization time based on a signal from the pressure sensor 23a and estimates a state of the assist region of the user P based on the recognition (FIG. 5/STEP01).

In this embodiment, the state of the assist region means a degree of damage made to the skin of the assist region. This degree of damage is calculated for each area of the assist region to which the assist force is transmitted by the first assist force application portions 23b and the second assist force application portions 23c by use of the magnitude and distribution of the pressure and the pressurization time which are detected by the pressure sensor 23a.

Next, the state recognition module 65a determines whether or not the degree of damage is equal to or larger than a predetermined threshold (FIG. 5/STEP02).

Specifically, for example, the determination is made based on whether or not a degree of damage of the whole of the assist region is equal to or larger than a predetermined value or whether or not an area exists where the degree of damage is equal to or larger than the predetermined value.

If the degree of damage is smaller than the threshold (if NO in STEP02), the process returns to STEP01, where the state recognition module 65a recognizes the state of the assist region again.

On the other hand, if the degree of damage is equal to or larger than the threshold (if YES in STEP02), the requested assist force recognition module 65b estimates an action of the user P based on a signal from the action sensor 41 that the knee joint mechanism 4 comprises and calculates a requested assist force for the action (FIG. 5/STEP03).

Next, the estimated assist force recognition module 5c estimates an action of the user P based on a signal from the pressure sensor 23a and a signal from the action sensor 41 that the knee joint mechanism 4 comprises and calculates an estimated assist force for a case where the switching control is executed based on a predetermined switching pattern (FIG. 5/STEP04).

Next, the assist force comparison module 65d determines whether or not the estimated assist force recognized by the estimated assist force recognition module 65c is equal to or larger than the requested assist force recognized by the requested assist force recognition module 65b (FIG. 5/STEP05).

If the estimated assist force is equal to or larger than the requested assist force (if YES in STEP05), the switching control module 65f executes the switching of the first assist force application portions 23b and the second assist force application portions 23c via the actuator 64 according to the predetermined switching pattern, and the current process ends (FIG. 5/STEP06).

In this embodiment, in switching one of the first assist force application portions 23b and the second assist force application portions 23c to the transmitting state, the predetermined switching pattern is used to switch the other of the first assist force application portions 23b and the second assist force application portions 23c to the non-transmitting state.

Due to this, in the case where for example, the first assist force application portions 23b are in the transmitting state, while the second assist force application portions 23c are in the non-transmitting state before the current switching control is started, the switching control module 65f switches the first assist force application portions 23b to the non-transmitting state and switches the second assist force application portions 23c to the transmitting state.

On the other hand, if the estimated assist force is smaller than the requested assist force (if NO in STEP05), the assist force comparison module 65d informs the user P via the speaker 66 of the assist force application mechanism 62 that in case the switching control continues, the assist force becomes insufficient (FIG. 5/STEP07).

Next, the stop request recognition module 65e determines whether or not a stop request has been issued from the user P within a predetermined period of time (FIG. 5/STEP08).

Specifically, the stop request recognition module 65e determines whether or not the switching stop switch 67 of the assist force application mechanism 62 has been depressed within the predetermined period of time which is determined in advance according to the estimated action of the user P.

If there has been issued no stop request within the predetermined period of time (if NO in STEP08), the process proceeds to STEP06, where the switching control module 65f executes the switching of the first assist force application portions 23b and the second assist force application portions 23c via the actuator 64 according to the predetermined switching pattern, and the current process ends.

On the other hand, if there has been issued a stop request within the predetermined period of time (if YES in STEP08), the switching control module 65f selects the targets which are kept staying in the transmitting state from the plurality of first assist force application portions 23b and the plurality of second assist force application portions 23c which stay in the transmitting state (FIG. 5/STEP09).

The targets are selected based on the state of the assist region of the user P recognized by the state recognition module 65a and the result of the comparison made by the assist force comparison module 65d between the requested assist force and the estimated assist force so that an assist force larger than the requested assist force can be transmitted after the switching is executed.

Specifically, the switching control module 65f selects at least one target which is stopped from being switched to the non-transmitting state (that is, a target which is kept staying in the transmitting state) from the first assist force application portions 23b and the second assist force application portions 23c in the transmitting state.

Next, the switching control module 65f execute the switching of the first assist force application portions 23b and the second assist force application portions 23c via the actuator 64 according to the result of the selection, and the current process ends (FIG. 5/STEP10).

Thus, as has been described heretofore, in the action assist apparatus A, the state of the assist region of the user P (particularly, the state of the skin) is recognized based on the result of the detection by the pressure sensor 23a, and the first assist force application portions 23b and the second assist force application portions 23c which are provided in the pad 23 are switched between the transmitting state and the non-transmitting state based on the recognized state.

Consequently, according to the action assist apparatus A, since the pressure applied to the assist region is controlled according to the state of the assist region, the pressurization of the assist region (then, a mounting region) can be suppressed.

Then, in the case where the control is executed based only on the state of the assist region, the assist force may become insufficient for the reason that the number of first assist force application portions 23b and second assist force application portions 23c which are configured to transmit the assist force to the assist region is not good enough. Additionally, depending upon the switching threshold set, the number of times of switching is increased, resulting in fears that an increase in consumed power is called for.

Then, in the action assist apparatus A, the requested assist force and the estimated assist force are calculated, and the result of the comparison of the calculated requested assist force with the calculated estimated assist force is reflected on the switching control. By doing so, in the action assist apparatus A, the number of times of switching becomes appropriate while suppressing the insufficiency of the assist force. Then, an increase in consumed power is suppressed, and an increase in overall size of the apparatus including a battery is also suppressed.

In addition, in the action assist apparatus A, the user P is informed of the result of the comparison made between the requested assist force and the estimated assist force via the speaker 66, and the request from the user P to stop the switching can be recognized (that is, the user P can select or determine whether or not the switching is necessary) before the result of the comparison is reflected on the switching control.

By adopting this configuration, since the switching control executed in the action assist apparatus A allows the switching to be executed at an appropriate timing which matches a request from the user P, the user hardly feels a sensation of physical disorder.

Thus, while the embodiment of the present invention has been described by reference to the accompanying drawings, the present invention is not limited to the embodiment.

For example, in the embodiment that has been described heretofore, in executing the switching control, when the estimated assist force is smaller than the requested assist force, the user P is informed of the fact via the speaker 66, causing the user P to determine whether or not the execution of the switching control is necessary. This is because the number of times of switching is made to be appropriate while suppressing the insufficiency of assist force, and the user P is prevented from feeling a sensation of physical disorder by incorporating a request of the user P in the control.

However, the action assist apparatus of the present invention is not limited to the configuration described above, and hence, any type of action assist apparatus may be adopted as long as the action assist apparatus can switch pluralities of assist force application portions as required.

For example, a configuration may be adopted in which even though the estimated assist force is smaller than the requested assist force, the control unit automatically selects one switching pattern from a plurality of switching patterns which are determined in advance so that an assist force larger than the requested assist force can be transmitted without informing the user P of the result of the comparison.

In the embodiment, a configuration may be adopted in which the switching control by the control unit 65 is executed only for the pad 23.

However, the present invention is not limited to the configuration described above, and hence, a configuration may be adopted in which the control unit executes the switching control on a member which is a different member from the pad provided on the lower leg region frame, as long as the member can transmit the assist force to the user.

For example, in the case of a configuration in which the assist force is transmitted to the user not only from the pad 23 on the lower leg region frame 2, which is the case described in the embodiment, but also from the body support member 14 of the thigh region frame 1, the body support member 14 on the thigh region frame 1 is given the same configuration as that of the pad 23, and the switching control is executed on the body support member 14 by the control unit 65. In the embodiment described above, the plurality of first assist force application portions 23b and the plurality of second assist force application portions 23c are arranged adjacent to each other so as to form the mosaic pattern. Namely, the first assist force application portions 23b and the second assist force application portions 23c are disposed within the single area.

However, the arrangement position of the first assist force application portions and the second assist force application portions is not limited to the configuration described above, and hence, any arrangement may be adopted, as long as the pressurization position differs where the assist region of the user is pressurized.

For example, when the action assist apparatus is a walking assist apparatus similar to the embodiment, the first assist force application portions may be disposed on the inner side of the thigh region frame (a first mounting device) mounted on the thigh region (a first assist region) of the user, and the second assist force application portions may be disposed on the inner side of the lower leg region frame (a second mounting device) mounted on the lower leg region (a second assist region).

Further, specifically speaking, in the case where the assist force is transmitted not only from the pad 23 of the lower leg region frame 2, as in the embodiment described above, but also from the body support member 14 of the thigh region frame 1, the switching control may be executed with the body support member 14 referred to as the first assist force application portion and the pad 23 as the second assist force application portion.

In the embodiment described above, the individual configurations are described as making up the action assist apparatus configured to assist the user to act. However, the action assist apparatus described above can also be used as a pressurization apparatus for use in designing action assist apparatuses by changing the force transmitted to the user not to the assist force but to a pressure for testing. As this occurs, the assist region becomes a pressurization region, and the assist force application portion becomes a pressure application portion.

Then, according to the pressurization apparatus configured in the way described above, since a pressure applied to the pressurization region is reduced according to the state of the pressurization region, the pressurization on the pressurization region (and hence, a mounting region including a plurality of pressurization regions) can be suppressed. In addition, disturbance can be suppressed which is caused by a change (for example, a tension of a muscle) in the state of the pressurization region.

What is claimed is:

1. An action assist apparatus comprising:
an actuator configured to generate driving force;
an assist mechanism configured to transmit the driving force to a user as assist force assisting the user to act;
a sensor configured to detect information regarding a state of an assist region of the user to which the assist force is transmitted; and
a control unit configured to control the actuator,
wherein the assist mechanism has a plurality of assist force application portions,
wherein each of the plurality of assist force application portions is switchable independently between a transmitting state in which the assist force is transmitted and a non-transmitting state in which the assist force is not transmitted based on a signal from the control unit, and
wherein the control unit recognizes the state of the assist region of the user based on a detection result by the sensor and switches at least one assist force application portion selected from the plurality of assist force application portions from one to the other of the transmitting state and the non-transmitting state based on the recognition.

2. The action assist apparatus according to claim 1, comprising:
a requested assist force recognition element configured to recognize requested assist force which is the assist force requested to assist the user to act; and
an estimated assist force recognition element configured to recognize estimated assist force before the respective assist force application portion is switched, the estimated assist force being the assist force estimated to be applied to the user via the assist mechanism after the switching is executed,
wherein the control unit compares the estimated assist force with the requested assist force, and in a case where the estimated assist force is smaller than the requested assist force, then stops at least one assist force application portion among the assist force application portions which is in the transmitting state from being switched to the non-transmitting state such that the assist force larger than the requested assist force can be transmitted.

3. The action assist apparatus according to claim 1, comprising:
a requested assist force recognition element configured to recognize requested assist force which is the assist force requested to assist the user to act;
an estimated assist force recognition element configured to recognize estimated assist force before the respective assist force application portion is switched, the estimated assist force being the assist force estimated to be applied to the user via the assist mechanism after the switching is executed;
an informing unit configured to inform the user that the estimated assist force is smaller than the assist force; and
a stop request recognition element configured to recognize a request from the user to stop the switching,
wherein the control unit compares the estimated assist force with the requested assist force, and informs the user in a case where the estimated assist force is smaller than the requested assist force, and upon recognizing a signal from the stop request recognition element, stops at least one assist force application portion among the plurality of assist force application portions in the transmitting state from being switched to the non-transmitting state such that the assist force larger than the requested assist force can be transmitted.

4. The action assist apparatus according to claim 1,
wherein the sensor detects at least one of the state of the assist region, a pressure applied to the assist region, a time period during which the assist force is applied to the assist region, a sum of time periods of the transmitting state of each of the assist force application portions, and a number of times each of the assist force application portions became the transmitting state.

5. The action assist apparatus according to claim 1,
wherein the plurality of assist force application portions include a first assist force application portion and a second assist force application portion, and
wherein the control unit switches the second assist force application portion to the non-transmitting state when switching the first assist force application portion to the transmitting state.

6. The action assist apparatus according to claim 1,
wherein the plurality of assist force application portions are disposed on an abutment surface which is brought into abutment with a body of the user so as to be aligned adjacent to one another.

7. The action assist apparatus according to claim 1, comprising:
a first mounting device adapted to be mounted on a first assist region of a body of the user; and
a second mounting device adapted to be mounted on a second assist region which is a portion different from the portion on which the first mounting device is mounted of a body of the user,
wherein part of the plurality of assist force application portions is disposed on the first mounting device and the other part is disposed on the second mounting device.

8. A pressurization apparatus comprising:
an actuator configured to generate driving force;
a plurality of pressure application portions configured to apply a predetermined pressure based on the driving force to a pressurization region of a body of a user;
a sensor configured to detect information regarding a state of the pressurization region of the user; and
a control unit configured to control the actuator,
wherein each of the plurality of pressure application portions is switchable independently between a transmitting state in which a pressure is transmitted and a non-transmitting state in which no pressure is transmitted based on a signal from the control unit, and
wherein the control unit recognizes the state of the pressurization region of the user based on a detection result by the sensor and switches at least one pressure application portion selected from the plurality of pressure application portions from one of the transmitting state and the non-transmitting state to the other based on the recognition.
